(19) United States
(12) Patent Application Publication
(10) Pub. No.: US 2010/0190050 A1
(43) Pub. Date: Jul. 29, 2010

(54) BATTERY ARRAY AND BATTERY ARRAY SEPARATOR

(76) Inventor: Shingo OCHI, Takasago City (JP)

Correspondence Address: WENDEROTH, LIND & PONACK, L.L.P., 1030 15th Street, N.W.,, Suite 400 East, Washington, DC, 20005-1503, US

(21) Appl. No.: 12/694,507

(22) Filed: Jan. 27, 2010

(30) Foreign Application Priority Data
Jan. 28, 2009 (JP) 2009-17353

(51) Int. Cl. H01M 2/24

(52) U.S. Cl. 429/160

(57) ABSTRACT

A battery array is provided with a plurality of rectangular battery cells 1 having electrode terminals 3, separators 2 inserted between adjacent rectangular battery cells 1 to insulate those rectangular battery cells 1, and connecting terminals 6 to electrically connect adjacent electrode terminals 3 of rectangular battery cells 1 stacked with intervening separators 2. Connecting terminals 6 are attached to electrode terminals 3 by a threaded fastening system, and separators 2 are provided with rotation prevention walls 9 that contact connecting terminals 6 and prevent connecting terminal 6 rotation during threaded fastener tightening. Consequently, connecting terminal 6 rotation during fastening is prevented, and deformation of a connecting terminal 6 or battery cell is prevented.

### BACKGROUND OF THE INVENTION

1. Field of the Invention

The present invention relates to battery array provided with a battery block having a plurality of stacked battery cells retained in a battery holder and to a separator used in that battery array, and in particular to a battery array having electrodes to connect with connecting terminals and to a separator used in that battery array.

2. Description of the Related Art

A battery system with many battery cells stacked together can attain high output voltages by connecting the battery cells in series. Consequently, this type of battery system is used in applications with high charging and discharging currents such as in a power source apparatus for a hybrid car or electric vehicle. The battery system is discharged with extremely high current to accelerate the vehicle, and is charged with significant current under conditions such as regenerative braking. The required output of the battery system is achieved by connecting many high capacity battery cells in series and/or parallel.

Connecting terminals such as bus-bars are used to connect individual battery cells. In a battery block that has battery cells stacked with intervening separators, individual electrodes of adjacent battery cells can be connected by bus-bars.

To simplify bus-bar connection, a bolt is fixed to the metal terminal that makes up a battery electrode. The bolt on the metal electrode is inserted through a bus-bar and a nut is threaded onto the bolt to tightly attach the bus-bar. (For example, refer to Japanese Laid-Open Patent Publication 2008-192595.)

To reliably obtain electrical output from a battery module, it is necessary to attach bus-bars and electrode metal terminals with certainty. Consequently, connection via screw threads is generally used. However, when a bolt on an electrode is inserted through a bus-bar and a nut is screwed on, torque is applied to secure connection. If the bus-bar or the electrode bolt turns together with the nut when torque is applied, there is fear of deformation or damage. In particular, compared to metal pieces such as the bus-bar and bolt, the battery cell includes structurally fragile parts that can be easily damaged. When torque is applied for nut and bolt tightening, there is concern that the upper surface of the battery cell could rotate and deform or rip apart. As a result, a special purpose assembly-rig is used in the prior art to prevent rotation during bus-bar connection.

A battery apparatus configured to prevent electrode rotation with tightening has been proposed as in Japanese Laid-Open Patent Publication 2008-277085. As shown in FIG. 12, the disclosed battery apparatus is provided with retaining pieces disposed adjacent to the battery modules. Battery modules have electrodes 21 for connection by bus-bars 81. Each electrode 21 has a metal terminal 41 extending from the battery module and a bolt 31 inserted through the metal terminal 41 configured with a wide region 35 at its aft end to prevent bolt extraction. The retaining pieces have contacting sections 64 that are in contact with the wide regions 35 of the bolts 31 to prevent bolt rotation. With this structure, the battery apparatus of FIG. 12 prevents rotation of the bolts and the electrodes when the nuts are tightened onto the bolts.

However, the structure described above requires use of a special shaped circular cylindrical bolt with one end having a box-shape to prevent bolt rotation. In addition, since there is direct contact with the electrode bolts in this structure, an insulating configuration is required to prevent unintended conduction and short circuits. As a result this battery apparatus has a large number of parts and a complex structure.

The present invention was developed with the object of resolving these types of problems. Thus, it is a primary object of the present invention to provide a battery array and battery array separator with a simple structure that allows connecting terminals to be tightly fastened to battery cells without causing damage, and allows prevention of electrode rotation with tightening when connecting terminals such as bus-bars are fastened to the electrodes.

### SUMMARY OF THE INVENTION

To realize the object described above, the battery array of the present invention is provided with a plurality of rectangular battery cells 1 having electrode terminals, separators 2 inserted between adjacent rectangular battery cells 1 to insulate the battery cells, and connecting terminals 6 to electrically connect electrode terminals of adjacent rectangular battery cells 1 stacked with intervening separators 2. The connecting terminals 6 are attached to the electrode terminals via screw tightening, and the separators 2 are provided with rotation prevention walls 9 that contact the connecting terminals 6 and prevent their rotation during screw tightening. In this manner, connecting terminal 6 rotation during screw tightening is prevented, and deformation of the connecting terminals 6 or battery cells is prevented.

In the second aspect of the battery array, each rectangular battery cell 1 upper surface is provided with insulating terminal holders 4 having inclined surfaces. Each electrode terminal passes through the inclined surface of a terminal holder 4 and is attached to the terminal holder 4 in a manner protruding at an inclined orientation. Separator 2 rotation prevention walls 9 are disposed on both sides to sandwich the terminal holder 4 inclined surfaces. As a result, by disposing the terminal holders 4 between rotation prevention walls 9, rotation of the electrode terminals attached to the terminal holders 4 can be prevented.

In the third aspect of the battery array, the rotation prevention walls 9 can be formed taller than the electrode terminals. Consequently, the electrode terminals can be enclosed by the rotation prevention walls 9, outward protrusion of the electrode terminals can be avoided, and unintended short circuits can be prevented.

In the fourth aspect of the battery array, the rotation prevention walls 9 can be formed longer than the connecting terminals 6. Consequently, the connecting terminals 6 can be surrounded by the rotation prevention walls 9, and unintended conduction can be averted.

In the fifth aspect of the battery array, the connecting terminals 6 have detection terminals 5, which detect the voltage of each rectangular battery cell 1, electrically connected to each connecting terminal 6. The separators 2 are formed with recessed regions 7 that sandwich part of the detection terminals 5, which are connected to the connecting terminals 6, and hold the detection terminals 5 in fixed dispositions. As a result of holding the detection terminals 5 with the recessed regions 7, these regions also have the effect of preventing connecting terminal 6 rotation.

In the sixth aspect of the battery array, metal endplates are provided that cover separators 2 positioned at both ends of the stack of rectangular batteries 1 and intervening separators 2 to sandwich and retain the stack. Separators 2 facing the endplates are provided with projections 13 that protrude outward in the direction of the endplates, and the endplates have insertion holes 14 to insert the projections 13. The insertion holes 14 are opened in asymmetric locations with respect to the centerline of the endplates. Consequently, separators 2 and endplates can be properly aligned, and incorrect attachment of the endplates in an inverted attitude can be avoided.

In the seventh aspect of the battery array, the surfaces of connecting terminals 6 that contact rotation prevention walls 9 can have rectangular shapes. As a result, connecting terminal 6 rotation can be easily prevented.

In the eighth aspect of the battery array, the bottom surface of each separator 2 can be provided with triangular ribs 11 having inclined surfaces that contact battery cell 1 corner edges (vertices). When the battery block including separators 2 is sandwiched between the endplates, rectangular battery cell 1 bottom surface corner vertices are pressed upon by the inclined surfaces of the triangular ribs 11, and the rectangular battery cells 1 are pushed upwards as a result of contact along the inclined surfaces. Consequently, rectangular battery cell 1 upper surfaces, where connecting terminals 6 attach, can be aligned in a single plane without deviation due to battery cell height variation. This has the merit that connecting terminals 6 can be reliably attached in a single plane.

In the ninth aspect of the separator for a battery array having a plurality of stacked rectangular batteries 1, battery array separators intervene between individual rectangular battery cells 1 to insulate those battery cells. A separator is provided with a frame 12 that establishes openings on both sides for rectangular battery cell 1 insertion, and a rotation prevention wall 9 that projects vertically from the upper surface of the frame 12. The rotation prevention wall 9 can be established in a location that covers electrode terminal side-walls and makes contact with the side-walls of the terminal holders 4 that hold the electrode terminals of rectangular battery cells 1 inserted in the frame 12 openings. As a result, when connecting terminals 6 are attached, connecting terminal 6 rotation is prevented and deformation of the connecting terminals 6 and battery cells is prevented.

In the tenth aspect of the battery array separator, the rotation prevention walls 9 can be established in locations that contact connecting terminals 6 with those connecting terminals 6 attached to battery cell 1 electrode terminals for battery cell 1 electrical connection. Consequently, when connecting terminals 6 are attached, connecting terminal 6 rotation is prevented and deformation of the connecting terminals 6 and battery cells is prevented.

The above and further objects of the present invention as well as the features thereof will become more apparent from the following detailed description to be made in conjunction with the accompanying drawings.

### BRIEF DESCRIPTION OF THE DRAWINGS

FIG. 1 is an oblique view showing the exterior of a battery array for the first embodiment of the present invention;

FIG. 2 is an enlarged oblique view showing the terminal region in FIG. 1;

FIG. 3 is an oblique view showing a rectangular battery cell with a separator attached to one side;

FIG. 4 is an oblique view showing the form of the separator of FIG. 3 with the rectangular battery cell removed;

FIG. 5 is a front view of the separator of FIG. 4;

FIG. 6 is a plan view of the separator of FIG. 4;

FIG. 7 is a vertical cross-section through the line VII-VII′ in FIG. 5;

FIG. 8 is a plan view of the separator of FIG. 3 with a rectangular battery inserted;

FIG. 9 is a cross-section showing rectangular battery cells inserted in the separators of FIG. 7;

FIG. 10 is an oblique view showing a connecting terminal;

FIG. 11 is an oblique view showing connecting terminals attached to a battery array for the second embodiment of the present invention; and

FIG. 12 is a cross-section showing the electrode structure of a prior art battery apparatus.

### DETAILED DESCRIPTION OF THE EMBODIMENT(S)

The following describes embodiments of the present invention based on the figures.

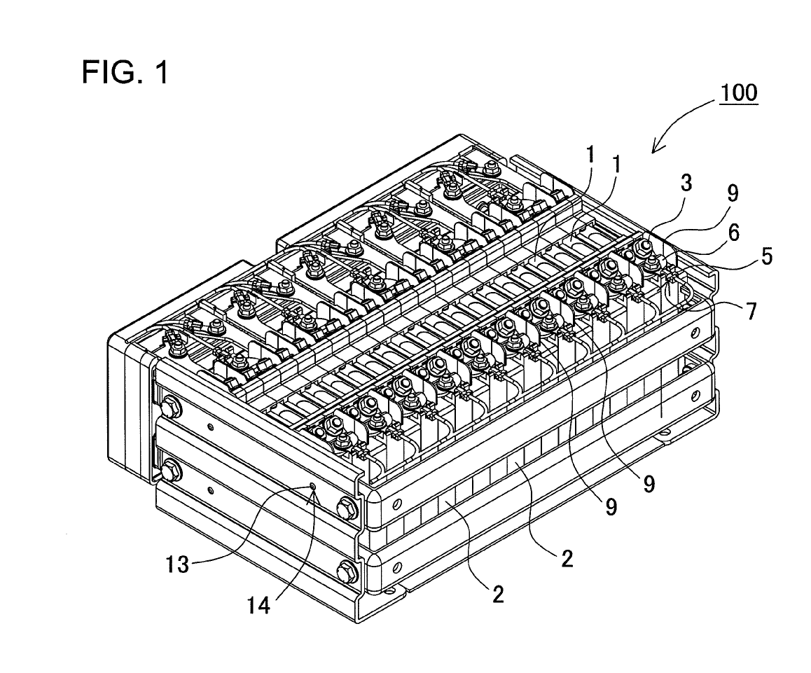

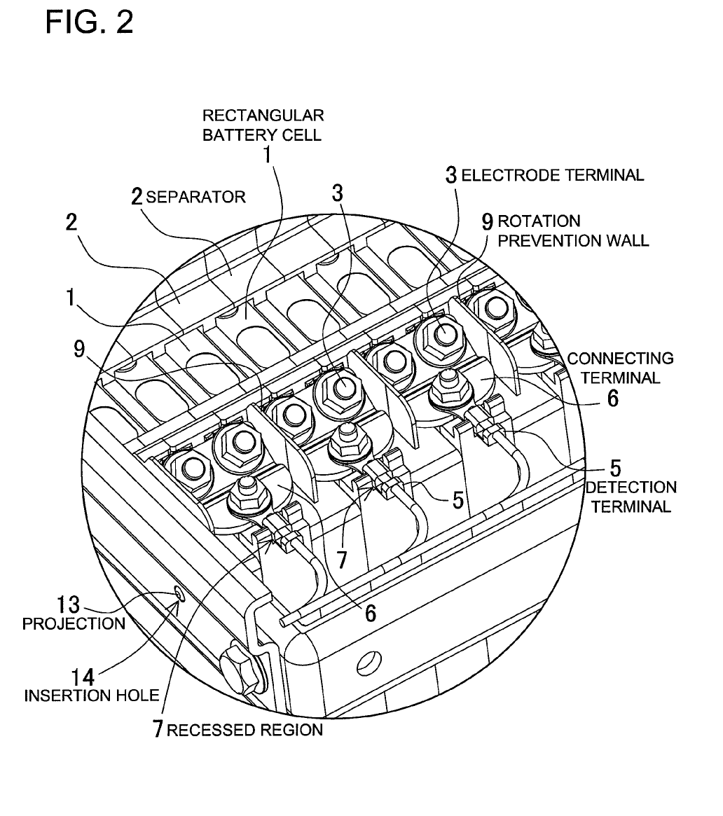

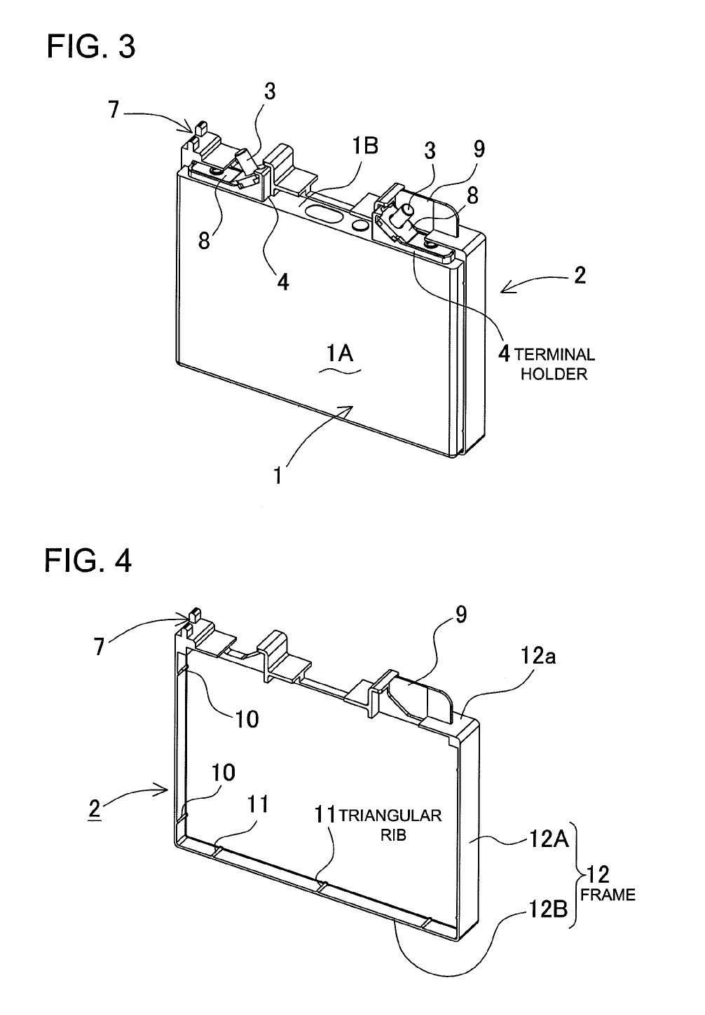

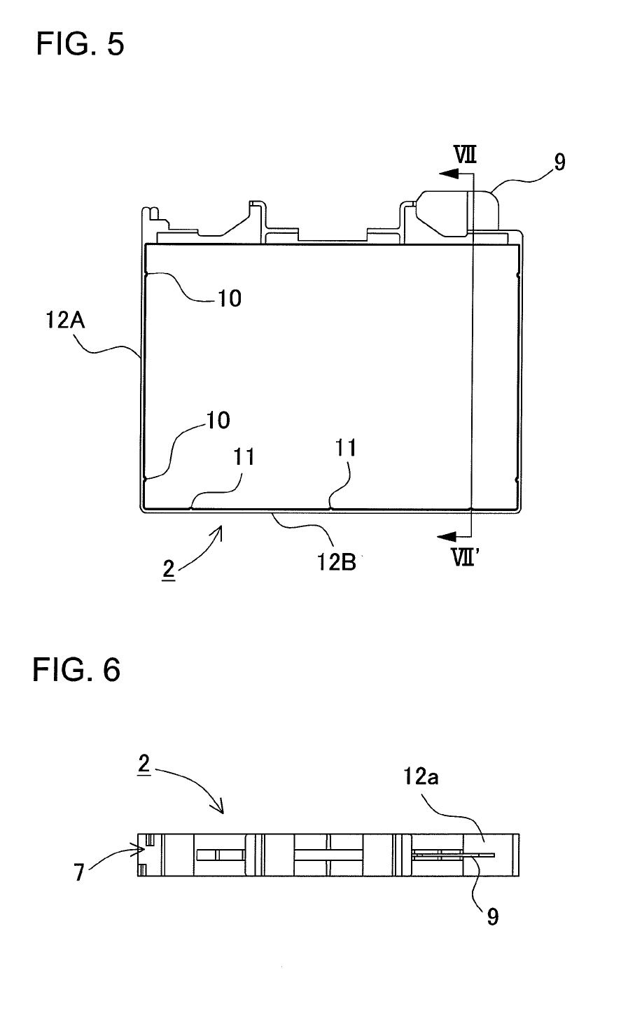

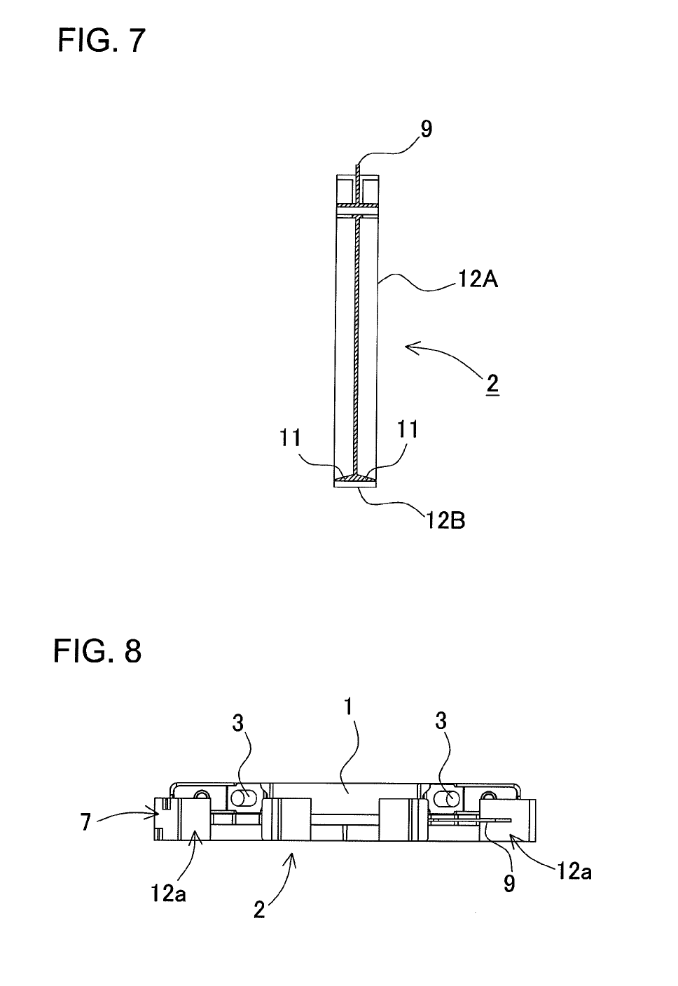

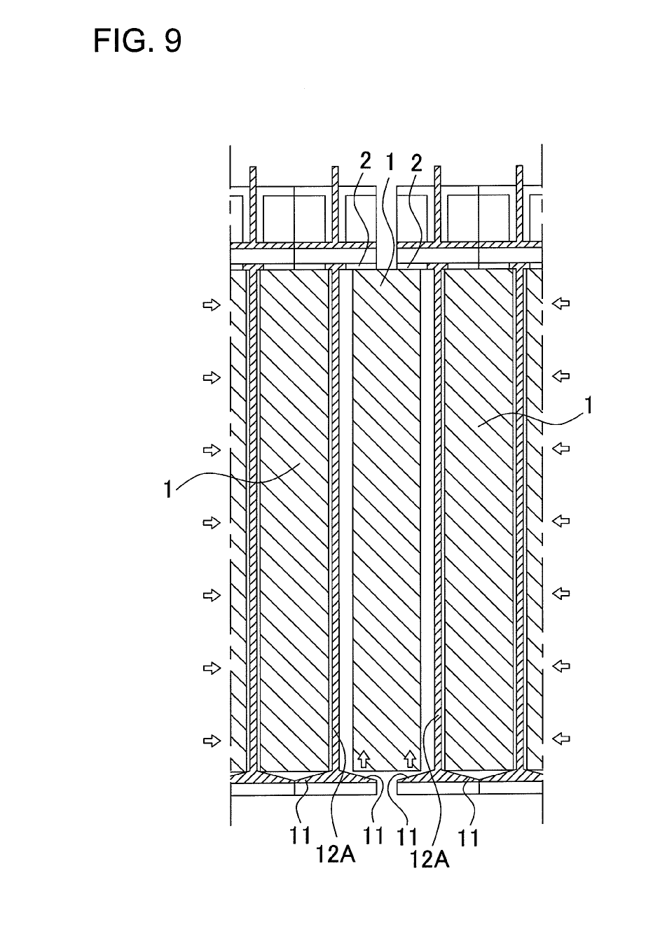

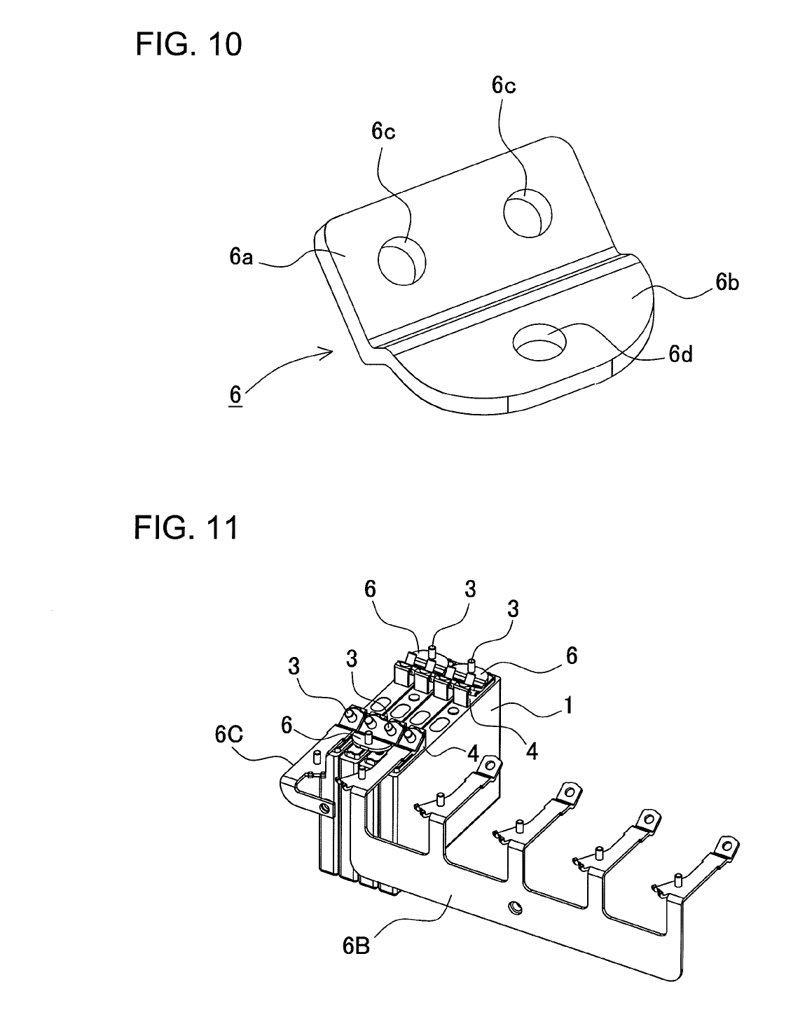

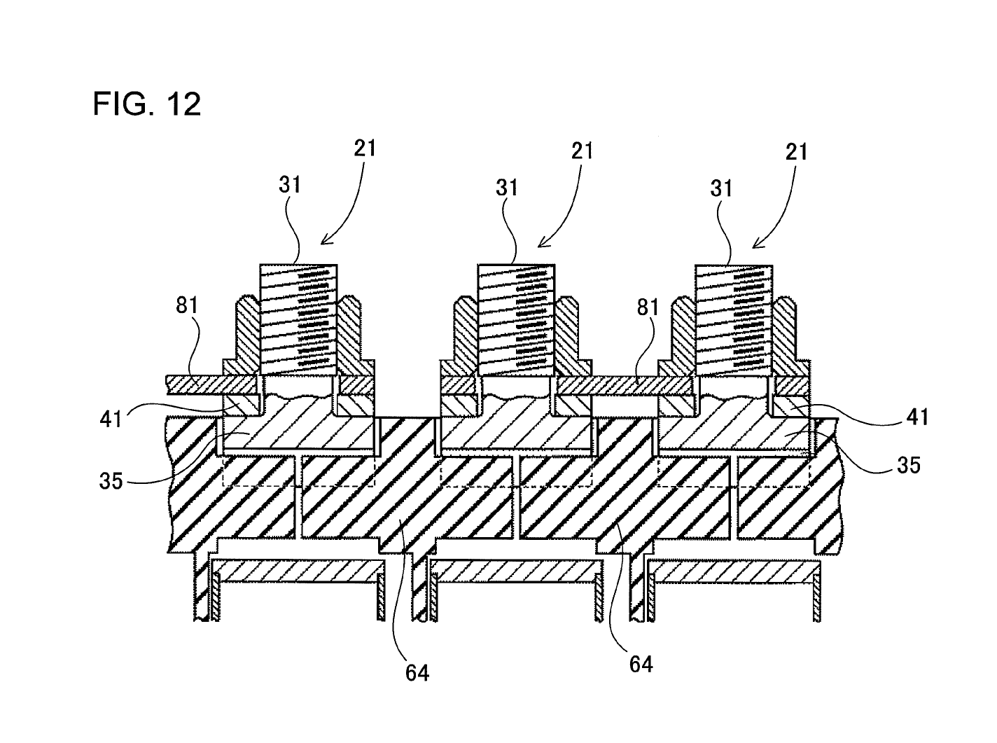

The figures show the following. FIG. 1 is an oblique view showing the exterior of a battery array for the first embodiment of the present invention, FIG. 2 is an enlarged oblique view showing the terminal region in FIG. 1, FIG. 3 is an oblique view showing a rectangular battery cell with a separator attached to one side, FIG. 4 is an oblique view showing the form of the separator of FIG. 3 with the rectangular battery cell removed, FIG. 5 is a front view of the separator of FIG. 4, FIG. 6 is a plan view of the separator of FIG. 4, FIG. 7 is a vertical cross-section through the line VII-VII′ in FIG. 5, FIG. 8 is a plan view of the separator of FIG. 3 with a rectangular battery inserted, FIG. 9 is a cross-section showing rectangular battery cells inserted in the separators of FIG. 7, FIG. 10 is an oblique view showing a connecting terminal, and FIG. 11 is an oblique view showing connecting terminals attached to a battery array for the second embodiment of the present invention. The battery array 100 shown in these figures is for automotive use, and is most suitably used as a power source primarily for an electrically powered vehicle such as a hybrid car, which is driven by both an engine and electric motor, or an electric automobile, which is driven by a motor only. The battery array can also be used in vehicles other than hybrid cars and electric automobiles.

The battery array 100 shown in FIG. 1 is made up of a battery block with a plurality of rectangular battery cells 1, which have conducting external case 1A surfaces, disposed in an insulating, stacked configuration.

A rectangular battery cell 1 is a thin rectangular battery with a thickness less than its width. Rectangular battery cells 1 are stacked in parallel orientation with separators 2 sandwiched between adjacent battery cells. As shown in FIG. 2, each rectangular battery cell 1 has a positive and negative electrode terminal 3 attached in a protruding fashion at the ends of the upper surface. The protruding positive and negative electrode terminals 3 are positioned with lateral (left-right) symmetry. As a result, rectangular battery cells 1 can easily be arranged in series by stacking with alternate battery cells flipped to adjacently dispose positive and negative electrodes. Battery array output voltage can be increased for high output by connecting the rectangular battery cells 1 in series. However, the rectangular battery cells of the battery array can also be connected in series and parallel.

The rectangular battery cells 1 are lithium ion batteries. However, rectangular battery cells are not limited to lithium ion batteries and any rechargeable batteries, such as nickel hydride batteries can be used. A rectangular battery cell 1 has an electrode unit, which is a stack of positive and negative electrode plates, contained in an external case 1A that is filled with electrolyte and hermetically sealed. As shown in FIG. 3, the external case 1A has a rectangular cylindrical shape with a closed bottom and an open top region that is closed off by a sealing plate 1B. The external case 1A is made of sheet metal such as aluminum or aluminum alloy, and is shaped by an impact press. The surfaces of the external case 1A are electrically conductive. Rectangular battery cells 1 that are stacked together are formed with a thin rectangular shape. The sealing plate 1B is also made from sheet metal such as aluminum or aluminum alloy. The sealing plate 1B has positive and negative electrode terminals 3 mounted at both ends via terminal holders 4.

### (Terminal Holders 4)

A terminal holder 4 is formed in a triangular shape with an inclined surface. Terminal holders 4 insulate the upper surface of a rectangular battery cell 1 in the regions around the electrode terminals 3 without insulating the protruding electrode terminals 3. The terminal holder 4 is formed from an insulating material such as plastic. A through-hole is formed through the inclined surface of a terminal holder 4, and an electrode terminal 3 is inserted through that hole. Electrode terminals 3 and terminal holders 4 are solidly mounted with the electrode terminals 3 protruding in an inclined fashion. To attach electrode terminals 3 and terminal holders 4, techniques such as screw or bolt attachment, bond attachment, or welding can be used. In this manner, electrode terminal 3 insulation and reinforcement can be achieved via the terminal holders 4.

Positive and negative electrode terminals 3 are connected internally to the positive and negative electrode plates. Electrode terminals 3 are preferably configured with threads in screw or bolt form. As shown in FIG. 2, connecting terminals 6 can be fastened to these types of electrode terminals 3 by screwing nuts onto the electrode terminals 3 where they protrude to the outside.

Electrode terminals 3 of adjacently stacked rectangular battery cells 1 can be connected via connecting terminals 6 for series connection. In addition, a detection terminal 5 is connected to an electrode terminal 3 of each rectangular battery cell 1. The detection terminals 5 are connected to protection circuitry that is mounted on a circuit board (not illustrated).

### (Connecting Terminals 6)

Connecting terminals 6 are attached to electrically connect the electrode terminals 3 of adjacent rectangular battery cells 1. The connection configuration is different depending on whether adjacent rectangular battery cells 1 are connected in series or parallel. Specifically, for parallel connection, positive electrode terminals are connected together and negative electrode terminals are connected together. For series connection, the positive and negative electrode terminals of adjacent rectangular battery cells are connected together.

The outline of a connecting terminal 6 is shown in FIG. 10. The connecting terminal 6 shown in FIG. 10 is a metal bus-bar with an inclined surface 6a that is bent to conform to the inclined surfaces of the terminal holders 4. The inclined surface 6a has two electrode terminal holes 6c for inserting the electrode terminals 3 of adjacent rectangular battery cells 1. On the other side, the horizontal surface 6b of the connecting terminal 6 has a single detection terminal hole 6d to attach a detection terminal 5.

### (Detection Terminals 5)

The detection terminals 5 detect the voltage of each rectangular battery cell 1, and are connected to a circuit board (not illustrated) via wire-leads. The detection terminals 5 of FIG. 2 are configured as circular terminals and are attached to connecting terminal 6 detection terminal holes 6d via nuts.

### (Recessed Regions 7)

As shown in FIG. 2, separators 2 are formed with recessed regions 7 that sandwich part of the detection terminals 5 that are attached to the connecting terminals 6. Separator 2 recessed regions 7 hold the detection terminals 5 in specified dispositions. A recessed region 7 is formed by a gap in one part of the upper edge of a separator 2 narrow side-wall. The inside dimension of a recessed region 7 is essentially the same size as part of a detection terminal 5. Further, a recessed region 7 is formed to hold a detection terminal 5 in a manner that projects at a right angle from the separator 2 side-wall when the detection terminal 5 has been attached to a connecting terminal 6.

As shown in figures such as FIGS. 3 and 6, the walls on both sides that form the open part of a recessed region 7 do not need to lie in the same plane, and lateral displacement can be established between those walls. Specifically, when a connecting terminal 6 is tightened onto an electrode terminal 3, detrimental rotation of the entire unit is more likely in one direction. To increase resistance to oppose rotation of the entire unit in that direction, it is advantageous to position the surface that opposes the nut tightening torque further to the outside of an arc centered at the nut. In the example of FIG. 2, the left side of a recessed region 7 is positioned further outside than the right side. In this manner, when a detection terminal 5 is tightened for attachment, the surface that opposes the tightening torque has an extended radius and offers more resistance. Further, the height of the walls on both sides of a recessed region 7 does not need to be the same, and one side can be made higher than the other. Accordingly, the amount of resistance to prevent rotation of an entire assembly unit can be increased by the form of the recessed regions 7, and a more reliable battery array can be produced.

### (Junction Piece 8)

In the example of FIG. 3, a junction piece 8 is provided that is bent to conform with the horizontal surface and the inclined surface of each terminal holder 4 to insure electrical connection between each connecting terminal 6 and electrode terminal 3. With the electrode terminal 3 inserted through a terminal holder 4, the junction piece 8 is attached to the electrode terminal 3 and covers the upper surface of the terminal holder 4. In this manner, the junction piece 8 extends over a wide area on the upper surface of the terminal holder 4 while making electrical connection with the electrode terminal 3. As shown in FIG. 2, by attachment of a connecting terminal 6 on top of the junction piece 8, the junction piece 8 intervenes between the connecting terminal 6 and the terminal holder 4 to make electrical connection over a wide area between the connecting terminal 6 and the electrode terminal 3.

### (Separator 2)

Rectangular battery cells 1 have separators 2 sandwiched between them. A separator 2 intervenes between adjacent rectangular battery cells 1, establishes a consistent interval between adjacent rectangular battery cells 1, and insulates those battery cells. Accordingly, a separator 2 is made of insulating material to insulate the external cases 1A of adjacent rectangular battery cells 1. This type of separator 2 is fabricated by molding an insulating material such as plastic. In addition, the separator can be provided with cooling gaps to induce flow of a cooling gas between opposing surfaces of adjacent rectangular battery cells 2 to cool those battery cells.

Although the separator 2 of FIG. 4 can be formed as a single piece, it can also be made up of a plurality of separate materials. For example, a separator formed from separate pieces can be provided with an insulating sheet that is disposed between opposing surfaces of adjacent rectangular battery cells, and a pair of separator pieces that sandwich the insulating sheet from both sides.

A separator 2 has a frame 12 that follows the outline of the rectangular battery cells 1, and open regions are established inside that frame 12. The frame 12 has vertical pieces 12A disposed along both narrow side-walls of the rectangular battery cells 1 and lateral pieces 12B disposed along upper and lower edges of the battery cells. The vertical pieces 12A and lateral pieces 12B are connected to form a rectangular shape. The vertical pieces 12A and lateral pieces 12B have a flat-plate form and follow the perimeter surfaces of the rectangular battery cells 1. The vertical pieces 12A have a width that can entirely cover rectangular battery cell 1 narrow side-walls on both sides when the rectangular battery cells 1 are stacked with intervening separators 2. The lateral pieces 12B are made up of horizontal segments 12a that follow the upper and lower surfaces of the rectangular battery cells 1. Horizontal segments 12a on the upper surfaces of the rectangular battery cells 1 are formed not covering, but rather exposing electrode terminals 3 and safety valve openings that are established on those upper surfaces. Horizontal segments 12a on the bottom surfaces of the rectangular battery cells 1 have the same width as the vertical pieces 12A, and can entirely cover rectangular battery cell 1 bottom surfaces when the rectangular battery cells 1 are stacked with intervening separators 2. This type of separator 2 can cover and insulate both side-walls and bottom surfaces of rectangular battery cells 1 stacked with separators 2 sandwiched between adjacent battery cells.

The separator 2 is provided with a rotation prevention wall 9. The rotation prevention wall 9 is made of insulating material and is preferably formed as a single piece with the separator 2. The rotation prevention wall 9 is established in a location that covers terminal holder 4 side-walls. In the example of FIGS. 3 and 4, the rotation prevention wall 9 is established approximately on the centerline of the upper surface of the separator 2 extending in a perpendicular direction in the form of a partition. The rotation prevention wall 9 completely covers the side-walls of triangular blocks formed by terminal holder 4 inclined surfaces. As shown in FIG. 3, rotation prevention walls 9 are designed with a height exceeding that of the electrode terminals 3 when the rectangular battery cell 1 side-walls are covered by separators 2. As shown in FIG. 2, the length of the rotation prevention walls 9 is designed long enough to cover connecting terminal 6 side-walls when those connecting terminals 6 are in-place on rectangular battery cell 1 electrode terminals 3. As a result, unintentional short circuits can be avoided by the complete coverage of electrode regions by the insulating rotation prevention walls 9.

As shown in FIGS. 2 and 3, when rectangular battery cells 1 are sandwiched between separators 2, terminal holders 4 and connecting terminals 6 are sandwiched between rotation prevention walls 9 and thereby held in a reliable fashion. Specifically, terminal holders 4 are held and reinforced by rotation prevention walls 9 during nut and bolt tightening to fasten connecting terminals 6 to the electrode terminals 3. Consequently, rotation of a terminal holder 4 or electrode terminal 3 together with nut rotation can be prevented.

In particular, since a battery electrode terminal 3 is not directly contacted and held, but rather the terminal holder 4 fixed to the electrode terminal 3 is held, this configuration has the merit of structural simplicity. Since a terminal bolt has a circular cylindrical shape, a special shaped bolt with a rectangular head was previously required to prevent rotation. However, the present embodiment uses a block-type terminal holder 4 to reinforce and insulate the terminal bolt. By holding the terminal holder 4 with parts of the separators 2, rotation of the electrode bolt during nut tightening can be effectively prevented. Consequently, since available materials can be effectively utilized, this configuration has the advantage that the structure for preventing unit rotation with tightening can be simple.

As described above, a separator 2 has horizontal segments 12a that make up the upper surface, and a rotation prevention wall 9 is provided at one end of that upper surface while a recessed region 7 is established at the other end. These separators 2 are inserted between rectangular battery cells 1 to establish a consistent space interval between adjacent rectangular battery cells 1 and insulate those battery cells. As shown in FIGS. 1 and 2, by alternately stacking separators 2 with reverse orientation, each rectangular battery cell 1 can be stacked with a rotation prevention wall 9 and a recessed region 7 disposed between adjacent battery cells while using a single type of separator 2.

As described above, the separator 2 shown in FIG. 4 is formed as a frame 12 with a base-plane at the floor of open regions that allow insertion of rectangular battery cells 1 to the left and right of the base-plane. The depth of the open regions is essentially half the width of a rectangular battery cell 1 or less than that. As a result, one rectangular battery cell 1 can be loaded between two separators 2. Separator 2 frames 12 have ribs 10 established on their inside surfaces, and gaps are formed between the separators 2 and rectangular battery cells 1 loaded in those separators 2. Rectangular battery cell 1 surfaces can be cooled by passing cooling air through those gaps. If necessary, the base-plane at the floor of the separator 2 open regions can be corrugated in a step up-step down fashion to form cooling gaps between the base-plane and opposing surfaces of rectangular battery cells 1 loaded in the separator 2. By passing cooling air through those cooling gaps, rectangular battery cell 1 cooling capability can be increased.

As shown in the cross-section of FIG. 9, it is advantageous to form the triangular ribs 11, which are positioned under the bottom surfaces of rectangular battery cells 1, with inclined surfaces. The inclined surfaces are formed sloping downward towards the mouths of the open regions of a separator 2. As shown in FIG. 9, when rectangular battery cells 1 are disposed in the separators 2, rectangular battery cell 1 corner regions or vertices contact the inclined surfaces. Specifically, when a battery block including separators 2 is sandwiched between endplates, the inclined surfaces of the triangular ribs 11 press against the corner regions of rectangular battery cell 1 bottom surfaces. As a result, rectangular battery cells 1 follow the triangular rib 11 inclined surfaces and are pushed upwards. When the rectangular battery cells 1 are pushed upwards, the upper surfaces of the battery cells come in contact with the inside surfaces of the separators 2 and are stopped at that point. Consequently, the upper surfaces of all the rectangular battery cells 1 are pushed up to conveniently align with the upper surfaces of the separators 2. If all the upper surfaces are aligned in a single plane when adjacent rectangular battery cells 1 are connected with connecting terminals 6, contact conditions are consistent and connection reliability is increased. Conversely, if rectangular battery cells 1 are connected at different heights, the connecting terminals 6 will attach with slanted orientation, contact areas will not be consistent, and contact resistance failure could result. In particular, when rectangular battery cells 1 are stacked together as a battery block, variation in battery cell height is an inherent result of dimensional tolerance allowed during battery cell production. Since the structure described above can uniformly align battery cell upper surfaces for this case as well, it is extremely effective from the standpoint of improving terminal connection reliability.

Further, the structure described above can align rectangular battery cell 1 gas exhaust valves for gas exhaust duct connection as well as aligning upper surfaces for connecting terminal 6 connection. Here, gas exhaust valve surfaces are aligned for attachment of the gas exhaust duct that exhausts gas discharged from the gas exhaust valves to the outside. Gas exhaust valves are provided to insure rectangular battery cell 1 safety by preventing battery cell destruction in the event of abnormal internal pressure increase due to over-charging or over-discharging. A gas exhaust valve opens to release gas when internal battery cell pressure rises abnormally. The gas exhaust duct is disposed in line with the locations of the rectangular battery cell 1 gas exhaust valves.

Consequently, the triangular ribs 11 function as guiding pieces that guide the rectangular battery cells 1 in an upward direction during battery block assembly.

### (Endplates)

A battery block of rectangular battery cells 1 stacked alternately with intervening separators 2 has endplates covering the separators 2 located at both ends. The battery block is sandwiched between the endplates and held by fastening components such as bolts. The endplates are made of metal such as aluminum or an alloy of aluminum, or they are molded from hard plastic. To sandwich the rectangular battery cells 1 over a wide area, endplates are made with an external shape that is the same rectangular shape as the rectangular battery cells 1. The rectangular endplates are made the same size as the rectangular battery cells 1 or very slightly larger. Plastic endplates can be stacked directly on the rectangular battery cells 1, while metal endplates are stacked on the rectangular battery cells 1 via a stacking material.

Endplates can be connected by attaching the ends of fastening components such as metal bands to the endplates. The ends of the metal bands can be connected to the endplates by set screws. Although the metal bands of FIG. 1 are connected to the endplates by set screws, metal band end regions can be folded inward to connect to the endplates, or the ends of the metal bands can be connected to the endplates by snapping or crimping into latches.

### (Projections 13)

In the example of FIGS. 1 and 2, separators 2 facing the endplates are provided with projections 13 that protrude outward in the direction of the endplates. Correspondingly, the endplates have insertion holes 14 formed for insertion of the projections 13. The insertion holes 14 are opened in asymmetric locations with respect to the centerline of the endplates. This asymmetry means that the projections 13 and insertion holes 14 do not align if the endplate is rotated 180°. As a result of this configuration, separators 2 and endplates can be aligned in proper positions via the projections 13 and insertion holes 14, and incorrect attachment of the endplates in an inverted attitude can be avoided.

Rectangular battery cells 1 stacked with intervening separators 2 are held in fixed positions by fastening components. The fastening components include the pair of endplates disposed at the end planes of the rectangular battery stack, and metal bands with ends connected to the endplates to hold the stack of rectangular battery cells 1 in a compressed state.

The metal bands are fabricated from sheet metal of a prescribed thickness and formed with a prescribed width. The ends of the metal bands connect to endplates to join the pair of endplates and hold the rectangular battery cells 1 in a compressed state between the endplates. Metal bands attach with prescribed dimensions to the pair of endplates to retain rectangular battery cells 1 stacked between the endplates in a prescribed state of compression. If the metal bands stretch with rectangular battery cell 1 expansion pressure, battery cell expansion cannot be prevented. Therefore, metal bands are made from sheet metal strong enough to avoid stretching with battery cell expansion pressure, and are formed with a width and thickness for sufficient strength from stainless steel such as SUS304, steel, or other sheet metal. Further, metal bands can also be formed with side-walls in the shape of channels or rails. Since metal bands with this shape can improve bending strength, they have the characteristic that stacked rectangular battery cells 1 can be robustly retained in a prescribed state of compression while reducing the metal band width. A metal band is provided with bent regions at its ends, and these bent regions are connected to the endplates. Set screw through-holes are established in the bent regions, and the metal bands are attached to the endplates via set screws inserted through the through-holes.

Further, the battery block shown in the oblique view of FIG. 1 has two rows of metal bands disposed at the top and bottom of both sides of the battery block and connected to the top and bottom of the endplates at both ends. In a battery block of this configuration, the two rows of metal bands can tightly connect the endplates.

The battery array 100 described above is assembled into a car power source apparatus. Although not illustrated, a power source apparatus equipped with this battery array 100 is provided with a plurality of temperature sensors to detect rectangular battery cell 1 temperature, a ventilation system to force cooling gas to flow through cooling ducts that branch into separate cooling gaps depending on rectangular battery cell 1 temperature detected by the temperature sensors, and control circuitry to control battery current depending on rectangular battery cell 1 temperature detected by the temperature sensors.

### Second Embodiment

FIG. 11 is an oblique view showing the connecting terminals 6 of a battery array for the second embodiment. In this figure, abbreviated illustration shows only one section of rectangular battery cells 1 (four rows on the left side) to make it easy to see the form of the connecting terminals, which are the bus-bars. Here, illustration of the separators 2 is also omitted. In FIG. 11, three types of connecting terminals are used. Second connecting terminals 6B, which are at the center and right side of the figure, are not provided to connect adjacent rectangular battery cells 1, but rather to connect rectangular battery cells 1 that are separated by an interval when the battery cells are in a stacked configuration. Second connecting terminals 6B are made up of horizontal pieces that have inclined surfaces disposed at given intervals in approximately parallel orientation, and connecting vertical pieces that are bent approximately perpendicular to the horizontal pieces.

A third connecting terminal 6C, which is at the left side of FIG. 11, is an end terminal that takes its terminal voltage to the outside. The third connecting terminal 6C has a horizontal piece with an inclined surface, and a vertical piece that is bent vertical and has an L-shape. Finally, the connecting terminal 6 between the second and third connecting terminals and the two connecting terminals 6 in the back are the same type as previously described in FIG. 10. Even in this example using connecting terminals of various shapes, detrimental unit rotation of a connecting terminal can be effectively prevented by using separators 2 provided with rotation prevention walls 9 (not illustrated in FIG. 11) as described previously. This is because even if a connecting terminal tries to rotate when torque is applied for attachment to an electrode terminal 3, the inclined surface of the connecting terminal is restrained by surrounding rotation prevention walls 9.

### APPLICATION IN THE INDUSTRY

The battery array and battery array separator of the present invention is well suited for use as a battery in a battery system installed on-board an automobile.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2009-17353 filed in Japan on Jan. 28, 2009, the content of which is incorporated herein by reference.

What is claimed is:

1. A battery array comprising:
a plurality of rectangular battery cells having electrode terminals;
separators inserted between adjacent rectangular battery cells to insulate those rectangular battery cells; and
connecting terminals to electrically connect adjacent electrode terminals of rectangular battery cells stacked with intervening separators,
wherein connecting terminals are attached to electrode terminals by a threaded fastening system; and separators are provided with rotation prevention walls that contact connecting terminals and prevent connecting terminal rotation during threaded fastener tightening.

2. The battery array as cited in claim 1 wherein the rectangular battery cell upper surface is provided with insulating terminal holders having inclined surfaces; electrode terminals pass through terminal holder inclined surfaces and are fixed to the terminal holders in a protruding fashion at an inclined disposition; and separator rotation prevention walls are disposed to hold the terminal holder inclined surface side-walls from both sides.

3. The battery array as cited in claim 1 wherein the rotation prevention walls are formed taller than the electrode terminals.

4. The battery array as cited in claim 1 wherein the rotation prevention walls are formed longer than the connecting terminals.

5. The battery array as cited in claim 1 wherein a detection terminal is electrically connected to a connecting terminal to detect rectangular battery cell voltage; and the separator has a recessed region formed to hold one part of the detection terminal and retain it in a fixed disposition when that detection terminal is attached to the connecting terminal.

6. The battery array as cited in claim 1 wherein metal endplates are provided covering separators at both ends of a stack of rectangular battery cells with intervening separators to hold the stack from both ends; the separators facing the endplates are provided with projections that protrude outward in the direction of the endplates; the endplates have insertion holes formed for insertion of the projections; and the insertion holes are opened in asymmetric locations with respect to the centerline of the endplates.

7. The battery array as cited in claim 1 wherein connecting terminal surfaces that make contact with rotation prevention walls have rectangular shapes.

8. The battery array as cited in claim 1 wherein bottom surfaces of the separators are provided with triangular ribs having inclined surfaces that contact corner region vertices of the rectangular battery cells.

9. A battery array separator that intervenes between individual rectangular battery cells in a battery array having a plurality of stacked rectangular battery cells to insulate those rectangular battery cells comprising:
a frame that forms open regions to insert rectangular battery cells on both sides; and
a rotation prevention wall projecting vertically from the upper surface of the frame;
wherein the rotation prevention wall covers the sides of the electrode terminals of rectangular battery cells inserted in the open regions, and is established in a position that contacts the side-walls of the terminal holders that anchor the electrode terminals.

10. The battery array separator as cited in claim 9 wherein the rotation prevention wall is established in a position that contacts side-walls of connecting terminals in the connected state, and those connecting terminals serve to electrically connect an electrode terminal of one rectangular battery cell with another rectangular battery cell.
